(19) United States
(12) Patent Application Publication
(10) Pub. No.: US 2024/0343156 A1
(43) Pub. Date: Oct. 17, 2024

(54) METHOD FOR DYNAMIC CHARGE STATUS MONITORING FOR AN ELECTRICALLY OPERATED WORK VEHICLE

(71) Applicant: DEERE & COMPANY, MOLINE, IL (US)

(72) Inventors: DOMINIK REITER, SCHWENNINGEN (DE); NORBERT FRITZ, ILVESHEIM (DE)

(21) Appl. No.: 18/600,899

(22) Filed: Mar. 11, 2024

(30) Foreign Application Priority Data
Apr. 17, 2023 (DE) 102023109529.3

(51) Int. Cl. B60L 58/12; B60L 53/30; B60L 53/65

(52) U.S. Cl. CPC B60L 58/12; B60L 53/305; B60L 53/65

(57) ABSTRACT

A method for dynamic charge status monitoring for an electrically operated work vehicle includes recording via a control unit a covered route between a start position of the work vehicle at the site of the charging station and a current operating position of the work vehicle, ascertaining via the control unit an average energy consumption of the work vehicle along the covered route, estimating via the control unit a total energy requirement of the work vehicle that needs to be reserved for returning from the current operating position to the start position along one of the covered route and a return route derived therefrom based on the covered route and the average energy consumption, and outputting via the control unit the estimated total energy requirement of the work vehicle that needs to be reserved as energy reserve information via a user interface.

### CROSS-REFERENCE TO RELATED APPLICATIONS

This application claims priority to German Patent Application No. 102023109529.3, filed Apr. 17, 2023, which is hereby incorporated by reference.

### FIELD OF THE DISCLOSURE

The disclosure relates to a method for dynamic charge status monitoring for an electrically operated work vehicle, which comprises a drive system having an electrical energy store which can be charged at a charging station.

### BACKGROUND

Electric vehicles can display a current charge status of the battery and an estimated remaining range. Electric vehicles can display a notification to recharge the battery when the current charge falls below a minimum charge status.

### SUMMARY

In automobiles, it is common for the current charge status of a rechargeable battery used to supply an electric traction drive to be visually presented on a vehicle display along with information relating to a predicted remaining range. The remaining range here is adapted according to a time-averaged energy consumption so that the actual consumption behavior can be taken into account to a certain extent. If the charge status falls below a certain specified minimum charge status, the driver receives corresponding information via the vehicle display, which prompts the driver to visit the nearest charging station.

Unlike automobiles, and also conventional utility vehicles, which are primarily intended for traveling on roads with a comparatively well-developed network of charging stations, agricultural work vehicles often do not have the option of recharging “en route”. It is instead necessary to return to the yard for this, and specifically to a charging station which is permanently installed there and is supplied with electrical energy from a photovoltaic system, for example. If the work vehicle is an agricultural tractor, the actual energy consumption is moreover subject to a plurality of further (external) influences due to it being used to universally carry out a variety of different work tasks, including the operation of associated add-on or accessory devices, with (road) transportation therefore constituting only one of many operating situations. In addition to careful work planning, accurate estimation of the charge status to enable a timely return to the charging station requires relevant experience on the part of the driver.

In light of this, the object of the present disclosure is to specify a method for dynamic charge status monitoring for an electrically operated work vehicle so that it takes into account conditions for agricultural applications to make it easier for the driver to estimate the correct charge status.

This object is achieved by a method having the features of one or more of the following embodiments.

The method for dynamic charge status monitoring for an electrically operated work vehicle, which comprises a drive system having an electrical energy store which can be charged at a charging station, provides that, via a control unit (e.g., a controller including a processor and memory), the course of a route covered between a start position of the work vehicle at the site of the charging station and a current operating position (which differs from the start position) of the work vehicle, including its altitude profile, is recorded, an average energy consumption of the work vehicle along the covered route is ascertained, based on the determined course of the route and the ascertained average energy consumption, a total energy requirement of the work vehicle that needs to be reserved for returning from the current operating position to the start position along the covered route or along a return route derived therefrom is estimated, and the estimated total energy requirement of the work vehicle that needs to be reserved is output as energy reserve information via a user interface.

The method according to the disclosure makes use of the fact—typical in agriculture—that an electrically operated work vehicle or an electrical energy store comprised therein is generally charged when stationary in a yard in order for the work vehicle to set off independently from there in the direction of a work process to be executed on a farm area (field, grassland, woodland, etc.). This applies especially if the work vehicle is designed as an agricultural tractor. After successfully executing the relevant work process, the agricultural tractor then usually returns on the same path to the yard and therefore to the charging station located there.

However, it is also possible that the agricultural tractor visits multiple farm areas in succession and, afterwards, returns to the yard on a different return path to the path on the way there. The recorded course of the covered route may be used in such cases as the basis for a probability-based derivation of the return route, for which, for example, cartographic information relating to a surrounding road and path network is evaluated by the control unit. The relevant cartographic information is provided, for example, by a GPS navigation system in conjunction with a topographic data bank. The average energy consumption ascertained along the covered route may be used here to predict an expected average energy consumption for the return route. The latter is then used to estimate the total energy requirement that needs to be reserved.

It should be noted that the method according to the disclosure is not restricted to a specific type of work vehicle; instead of a work process to be executed on a farm area, it may equally refer to transportation via a trailer, which takes place between the yard and a specific loading point.

The altitude profile recorded by the control unit enables the uphill and downhill gradients along the covered route to be ascertained and is used, for example, to calculate or account for the (potential) energy which is to be used or which can be recovered by the work vehicle when driving back to the charging station. The course of the route, including the altitude profile, is captured by a GPS navigation system, for example, which communicates with the control unit.

To output the energy reserve information, this is for example made apparent to the driver by visual and/or auditory means, for which the user interface may have a display and/or an audio response unit. The user interface here may be permanently installed in the work vehicle, although it may also be a mobile telephone or the like, which is in data-exchanging communication with the control unit via a wireless interface.

By taking into account the course of the covered route in conjunction with the corresponding average energy consumption of the vehicle, dynamic adaptation of the energy reserve information output via the user interface is enabled so that effective use of the energy supply available in the electrical energy store is ensured both for the purpose of carrying out a respective work process and for an uninterrupted return journey to the charging station. This also enables a driver who is less familiar with the relevant work vehicle or work process to estimate the charge status of the electrical energy store correctly and return to the charging station in good time.

Advantageous embodiments of the method according to the disclosure can be found in one or more of the following embodiments.

The control unit for example outputs the energy reserve information via the user interface as remaining work time based on a comparison of the estimated total energy requirement that needs to be reserved and the current energy consumption of the work vehicle as well as the current charge status of the electrical energy store. Reproducing the energy reserve information as time information represents a variable which is familiar to users in the agricultural field and is therefore particularly easy to estimate.

It is furthermore possible that the average energy consumption along the covered route is ascertained by the control unit according to one or more characteristic parameters for the operation of the work vehicle. The characteristic parameters for example represent factors which have an (in) direct influence on the energy consumption of the relevant work vehicle.

Firstly, the characteristic parameters may relate to a road surface and/or ground type determined by the control unit. Amongst other things, a classification of the covered route into categories such as “road”, “farm path”, “field area to be worked” may take place here. The relevant assignations can be obtained from cartographically located metadata of the GPS navigation system communicating with the control unit. As a result of the classification created in this way, the computational averaging when ascertaining the average energy consumption does not take place over the whole route, but rather section by section for traveling conditions which differ in terms of their driving characteristics and therefore their energy requirement. The accuracy when predicting or estimating the total energy requirement of the work vehicle that needs to be reserved or the energy reserve information can therefore be notably increased or refined.

Similar observations apply with regard to further factors which influence the energy consumption. In the case of a work vehicle designed as an agricultural tractor, this applies for example to the type of work process which is executed or is to be executed thereby, for example the type of add-on or accessory device used for this purpose, since this either results in an altered traction requirement or, in turn, comprises work units for executing associated add-on device functions which need to be supplied with energy via a power take-off shaft or an ISOBUS interface. The variance in the energy consumption is correspondingly wide here. It is therefore conceivable that the average energy consumption of the work vehicle along the covered route is ascertained by the control unit depending on a detected operation which does not involve a device or an operation which involves an add-on or accessory device. The control unit concludes that an add-on or accessory device is present, for example, based on a significantly increased energy consumption compared to a calibration value which has been previously ascertained for an operation which does not involve a device.

In this respect, a further refinement can be achieved if, when ascertaining the average energy consumption of the work vehicle along the covered route, a change in the loading weight of the add-on or accessory device, which occurs depending on the operation, is taken into account by the control unit. A change in the loading weight results in a characteristically decreasing or increasing energy consumption and is typical for add-on or accessory devices designed as fertilizer distributors, self-loading bale trailers, slurry spreaders, manure spreaders, seed planters, or the like.

Other conditions may also influence the charge capacity of the electrical energy store which can be used to operate the work vehicle, for example including temperature conditions. In light of this, it is possible for the average energy consumption of the work vehicle along the covered route to be ascertained by the control unit depending on the determined surrounding temperature.

Furthermore, the estimated total energy requirement, including the associated course of the route and/or the characteristic parameters, may be stored by the control unit in a memory device and thus documented. As a result of the data which is added each time the same route is traveled, the quality of the estimation of the total energy requirement can be successively improved by reducing the variance. If is furthermore possible that any data gaps in terms of the characteristic parameters may be inferred by the control unit through approximation, for example using a suitable AI process (AI—Artificial Intelligence).

The above and other features will become apparent from the following detailed description and accompanying drawings.

### BRIEF DESCRIPTION OF THE DRAWINGS

The method according to the disclosure will be explained in more detail hereinafter on the basis of the appended drawings. Here, corresponding reference signs relate to identical components or components which are comparable with respect to their function. In the drawings:

FIG. 1 shows an example embodiment of the method according to the disclosure for dynamic charge status monitoring for an electrically operated work vehicle, presented as a flow chart;

FIG. 2 shows a device provided to execute the method according to the disclosure according to FIG. 1; and

FIG. 3 shows an illustration of a typical operating or work sequence of a work vehicle designed as an electrically operated agricultural tractor.

### DETAILED DESCRIPTION

The embodiments or implementations disclosed in the above drawings and the following detailed description are not intended to be exhaustive or to limit the present disclosure to these embodiments or implementations.

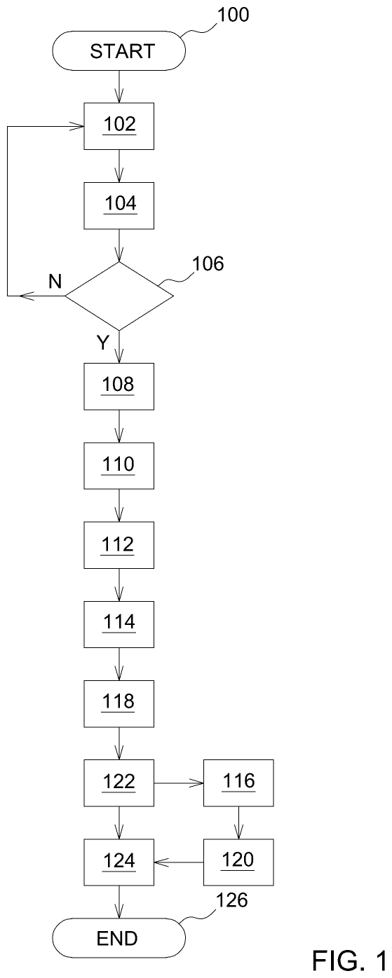

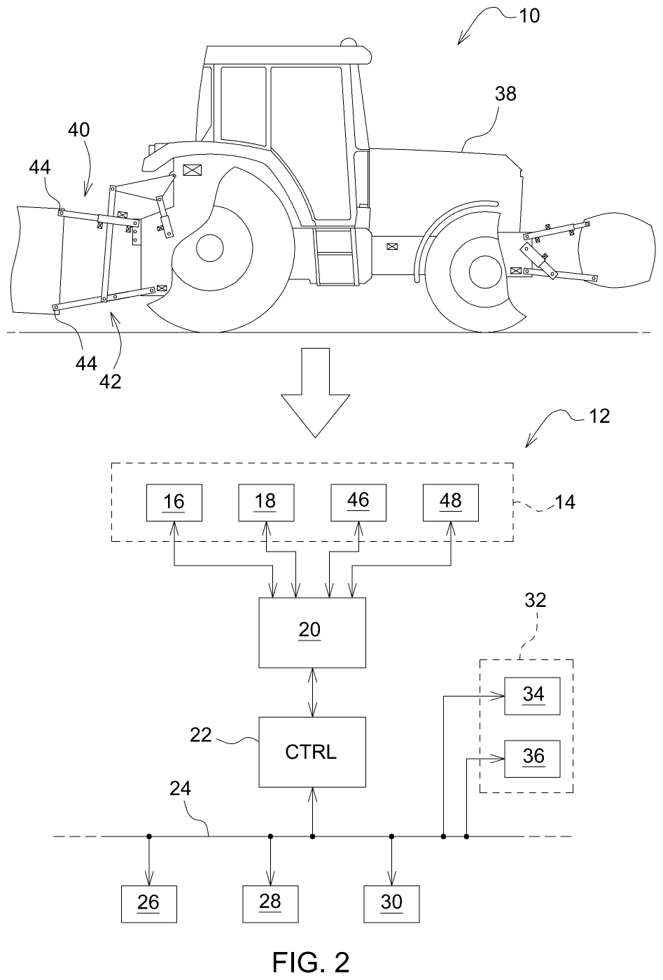

FIG. 1 shows an example embodiment of the method according to the disclosure for dynamic charge status monitoring for an electrically operated work vehicle, presented as a flow chart, wherein the device corresponding to FIG. 2, which is provided to execute the method, shall firstly be discussed.

In addition to a drive system 14, which has an electrical energy store 16, which can be charged at a charging station, and an electric traction drive 18, the device 12 accommodated in the work vehicle 10 has an energy and charge management system 20 which communicates with the drive system 14, a microprocessor-controlled control unit 22, in which the method is stored as a corresponding program code, and a CAN data bus 24, via which the control unit 22 is in communication with a GPS navigation system 26, a memory unit 28, a temperature sensor 30 for recording the surrounding temperature, and a user interface 32. The user interface 32 in turn has a display 34 and/or an audio response unit 36. The drive system 14 in the present case is designed in such a way that it enables the recovery of electrical energy during braking of the work vehicle 10.

By way of example, the work vehicle 10 is an agricultural tractor 38 having a coupling device 40 to which an agricultural add-on or accessory device can be attached. In the present case, the coupling device 40 arranged in the rear region 42 of the agricultural tractor 38 is in the form of a three-point power lift 44 or a trailer ball coupling (not shown), wherein a power take-off shaft 46 and/or ISOBUS interface 48, associated with the coupling device 40, serves as a further component part of the drive system 14 for supplying energy for associated add-on device functions. In this case, the ISOBUS interface 48 comprises a so-called standardized AEF connector, via which different supply voltages (480 volts AC or 700 volts DC) can be provided.

The function of the above-mentioned components shall now be described within the context of the method sequence presented in FIG. 1.

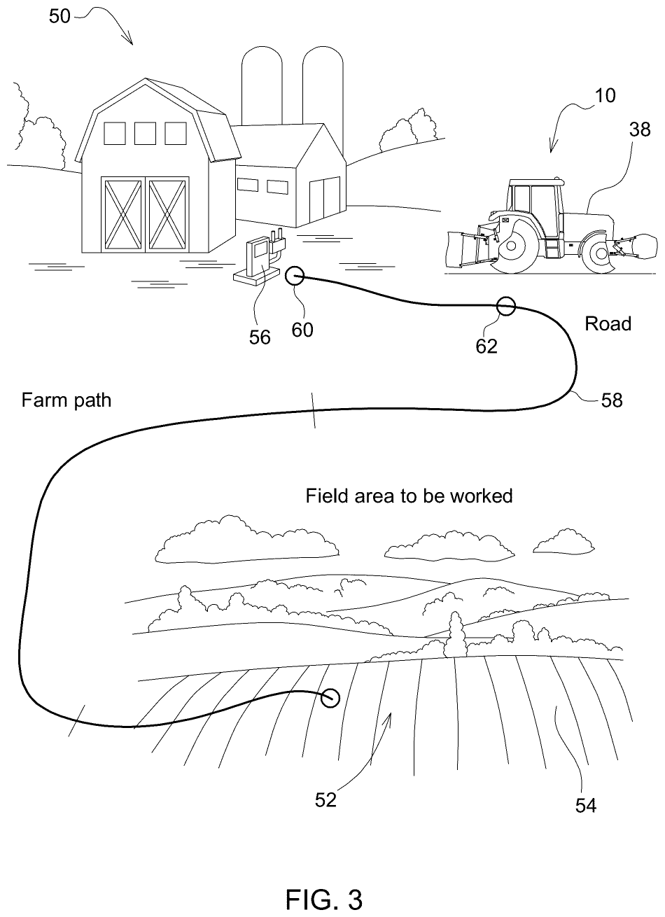

For better understanding, please refer at the same time to FIG. 3, in which an illustration of a typical operating or work sequence of the agricultural tractor 38 is shown. The method presented in FIG. 1 makes use of the fact—typical in agriculture—that the agricultural tractor 38 or the electrical energy store 16 comprised therein is generally charged when stationary in a yard 50 in order for the agricultural tractor to set off independently from there in the direction of a work process to be executed on a farm area 52, for example in a field 54. After successfully executing the relevant work process, the agricultural tractor 38 then returns on the same path to the yard 50 and therefore to the charging station 56 located there.

As can be seen in FIG. 1, the method is initiated in a starting step 100 when the agricultural tractor 38 is started up and is then run periodically, typically at intervals of a few 100 ms.

In a first main step 100 following the starting step 100, the spatial coordinates of the agricultural tractor 38 are firstly determined by the control unit 22 using the GPS navigation system 26 and stored as a corresponding position dataset in the memory unit 28. During the periodic running of the method, the course of the entire route 58 covered by the agricultural tractor 38, from the start position 60 at the site of the charging station 56 to its current operating position 62, including its altitude profile, is recorded.

In a second main step 104, a road surface and/or ground type corresponding to the current operating position 62 is additionally determined by the control unit 22 and assigned to the relevant position dataset in the memory unit 28. Amongst other things, a classification of the covered route 58 into categories such as “road”, “farm path”, “field area to be worked” takes place (see FIG. 3 in this regard). The relevant assignations are obtained from cartographically located metadata of the GPS navigation system 26.

Then, in a third main step 106, the control unit 22 checks whether the current operating position 62 of the agricultural tractor 38, as determined in the first main step 102, is within a radius of a few 100 meters from the specified site of the charging station 56, and therefore the start position 60. If this is not the case, the method returns to the first main step 102. Otherwise the control unit 22 continues with a fourth main step 108, in which, starting with the altitude profile recorded by the control unit 22, the uphill and downhill gradients along the covered route 58 are ascertained, wherein these are in turn used to calculate or account for the (potential) energy which is to be used or which can be recovered by the agricultural tractor 38 when driving back to the charging station 56.

In a fifth main step 110 following the fourth main step 108, an average energy consumption avg_E of the agricultural tractor 38 along the covered route 58 is ascertained by the control unit 22. Specifically, the ascertainment thereof takes place according to one or more characteristic parameters for the operation of the agricultural tractor 38. The characteristic parameters represent factors which have an (in) direct influence on the energy consumption of the agricultural tractor 38. The ascertainment of the average energy consumption avg_E takes place in the fifth main step 110 based on an energy consumption model which is stored in the memory unit 28 and is selected or adapted according to the characteristic parameters involved.

The amount of energy consumed is primarily a consequence of the operation of the electric traction drive 18 depending on the driving behavior of the driver or the driving speed specified by the driver, but is also based on further factors relating to the operation of peripheral consumers, such as work units which are to be supplied with energy via the power take-off shaft 46 or the ISOBUS interface 48 for executing associated add-on device functions and/or diverse hydraulic or electrical auxiliary units of the agricultural tractor 38. The relevant information is determined by the control unit 22 in the fifth main step 110 by reading the energy and charge management system 20 and possibly from operating information transmitted via the ISOBUS interface 48 or the CAN data bus 26 and is contextualized with the current operating position 62 of the agricultural tractor 62, which is detected in the first main step 102. This information is supplemented by characteristic parameters in the form of the road surface and/or ground type determined for the current operating position 62 of the agricultural vehicle 38 in the second main step 104, the energy which is to be used or which can be recovered due to an uphill or downhill gradient, as calculated in the fourth main step 108, and the surrounding temperature detected by the temperature sensor 30.

Added factors relate to the traction requirement of an add-on or accessory device which is possibly attached to the agricultural tractor 38 and the resultant influence on the energy consumption.

In a sixth main step 112, the control unit 22 concludes that an add-on or accessory device attached to the coupling device 40 is present if, from reading the energy and charge management system 20, it is revealed that there is a significant increase in energy consumption compared to a calibration value which has been previously ascertained for an operation which does not involve a device.

If this is the case, the control unit 22 furthermore checks, in a seventh main step 114, whether the loading weight of the add-on or accessory device has changed due to the operation. A change in the loading weight results in a characteristically decreasing or increasing energy consumption and is typical for add-on or accessory devices designed as fertilizer distributors, self-loading bale trailers, slurry spreaders, manure spreaders, seed planters, or the like.

If the add-on or accessory device is ISOBUS-compatible, this can be identified with the aid of device code transmitted via the ISOBUS interface 48. The analysis of the energy consumption carried out in the sixth and seventh main step 112, 114 is superfluous in such a case.

The average energy consumption avg_E ascertained in such a way is then used to estimate a total energy requirement sum_E of the agricultural tractor 38 that needs to be reserved for returning from the current operating position 62 to the start position 60 along the covered route 58. When estimating the total energy requirement sum_E, components of the average energy consumption avg_E which do not play a role when returning to the yard 50, particularly since they are not typically relevant here, are not taken into account by the control unit as a result of being deliberately filtered out. In the case of an add-on device designed as a slurry spreader, this relates to the operation of a circulating pump, for example. This is shut down after all of the slurry has been extracted and therefore does not consume energy on the return journey. Via the control unit 22, the consumption components to be filtered out are identified and taken into account accordingly within an energy consumption model for the relevant add-on or accessory device, which energy consumption model is stored in the memory unit 28 and is used to ascertain the average energy consumption avg_E in the fifth main step 110.

Specifically, the estimation of the total energy requirement sum_E that needs to be reserved takes place in a first substep 116 under the condition, checked in an eighth main step 118, that the route 58 covered up to the current operating position 62 has not already been previously traveled or recorded and/or the operating conditions specified by the characteristic parameters in this regard are not comparable with each other. In a second substep 120, the total energy requirement sum_E estimated in the first substep 118 in such a case is stored in the memory unit 28, along with the associated course of the route 58 and/or the characteristic parameters, and thus documented. Any data gaps in terms of the characteristic parameters are inferred by the control unit 22 here through approximation, for example using a suitable AI process (AI-Artificial Intelligence).

However, if it is revealed that the course of the route 58 covered up to the current operating position 62 has already been traveled or recorded in the past and the operating conditions specified by the characteristic parameters in this regard are comparable with each other, the total energy requirement sum_E stored in this respect in the memory unit 28 is accessed directly by the control unit 22. A new estimation is omitted in this case.

The estimated total energy requirement sum_E of the agricultural tractor 28 is finally output via the user interface 32 as energy reserve information at the prompt of the control unit 22 in a ninth main step 122. To this end, this is made apparent to the driver by visual and/or auditory means through activation of the display 34 and/or the audio response unit 36.

A tenth main step 124 additionally provides for the energy reserve information to be output as remaining work time, wherein the control unit 22 calculates this via the user interface based on a comparison of the estimated total energy requirement sum_E that needs to be reserved and the current energy consumption of the agricultural tractor 38 as well as the current charge status of the electrical energy store 16. Information relating to the current energy consumption and the current charge status of the electrical energy store 16 is made available to the control unit 22 by the energy and charge management system 20.

In a final step 126, the method is ended when the agricultural tractor 28 is switched off.

It should be noted that the method according to the disclosure is not restricted to a specific type of work vehicle 10; instead of a work process to be executed on a farm area 52, it may equally refer to transportation via a trailer, which takes place between the yard 50 and a specific loading point.

Deviating from the illustration in FIG. 3, it is also possible that the agricultural tractor 38 visits multiple farm areas in succession and, afterwards, returns to the yard 50 on a different return path to the path on the way there. The recorded course of the covered route 58 is used in such a case as the basis for a probability-based derivation of the return route, for which, for example, cartographic information relating to a surrounding road and path network is evaluated by the control unit 22. The relevant cartographic information is provided by a GPS navigation system 26 in conjunction with a topographic data bank. The average energy consumption avg_E ascertained along the covered route 58 is used by the control unit 22 here to predict an expected average energy consumption avg_E for the return route. This average energy consumption is then used in a first substep 118 to estimate the total energy requirement sum_E that needs to be reserved.

The terminology used herein is for the purpose of describing example embodiments or implementations and is not intended to be limiting of the disclosure. As used herein, the singular forms “a,” “an,” and “the” are intended to include the plural forms as well, unless the context clearly indicates otherwise. It will be further understood that the any use of the terms “has,” “includes,” “comprises,” or the like, in this specification, identifies the presence of stated features, integers, steps, operations, elements, and/or components, but does not preclude the presence or addition of one or more other features, integers, steps, operations, elements, components, and/or groups thereof.

Those having ordinary skill in the art will recognize that terms such as “above,” “below,” “upward,” “downward,” “top,” “bottom,” etc., are used descriptively for the drawings, and do not represent limitations on the scope of the present disclosure, as defined by the appended claims. Furthermore, the teachings may be described herein in terms of functional and/or logical block components or various processing steps, which may include any number of hardware, software, and/or firmware components configured to perform the specified functions.

Terms of degree, such as “generally,” “substantially,” or “approximately” are understood by those having ordinary skill in the art to refer to reasonable ranges outside of a given value or orientation, for example, general tolerances or positional relationships associated with manufacturing, assembly, and use of the described embodiments or implementations.

As used herein, “e.g.,” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

While the above describes example embodiments or implementations of the present disclosure, these descriptions should not be viewed in a restrictive or limiting sense. Rather, there are several variations and modifications which may be made without departing from the scope of the appended claims.

What is claimed is:

1. A method for dynamic charge status monitoring for an electrically operated work vehicle, which comprises a drive system having an electrical energy store which can be charged at a charging station, comprising:
recording via a control unit a covered route between a start position of the work vehicle at the site of the charging station and a current operating position, which differs from the start position, of the work vehicle, including its altitude profile;
ascertaining via the control unit an average energy consumption of the work vehicle along the covered route;
estimating via the control unit a total energy requirement of the work vehicle that needs to be reserved for returning from the current operating position to the start position along one of the covered route and a return route derived therefrom based on the covered route and the average energy consumption; and
outputting via the control unit the estimated total energy requirement of the work vehicle that needs to be reserved as energy reserve information via a user interface.

2. The method of claim 1, wherein the control unit outputs the energy reserve information via the user interface as remaining work time based on a comparison of the estimated total energy requirement that needs to be reserved and the current energy consumption of the work vehicle as well as the current charge status of the electrical energy store.

3. The method of claim 1, wherein the average energy consumption along the covered route is ascertained by the control unit according to one or more characteristic parameters for the operation of the work vehicle.

4. The method of claim 3, wherein the characteristic parameters relate to one or more of a road surface and a ground type determined by the control unit.

5. The method of claim 3, wherein the characteristic parameters relate to a type of work process.

6. The method of claim 3, wherein the characteristic parameters relate to a detected operation.

7. The method of claim 3, wherein the characteristic parameters relate to a determined surrounding temperature.

8. The method of claim 3, wherein the characteristic parameters relate to one or more of energy which is to be used due to an uphill and energy which can be recovered due to a downhill gradient.

9. The method of claim 3, wherein the estimated total energy requirement is stored by the control unit in a memory unit, along with the covered route and the characteristic parameters.

10. The method of claim 9, wherein any data gaps in terms of the characteristic parameters are inferred by the control unit through approximation, for example using an AI process.

11. A system for dynamic charge status monitoring for an electrically operated work vehicle, comprising:
a drive system having an electrical energy store which can be charged at a charging station, in which,
a control unit configured to record a covered route covered between a start position of the work vehicle at the site of the charging station and a current operating position, which differs from the start position, of the work vehicle, including its altitude profile, to ascertain an average energy consumption of the work vehicle along the covered route, to estimate a total energy requirement of the work vehicle that needs to be reserved for returning from the current operating position to the start position along one of the covered route and a return route derived therefrom based on the covered route and the average energy consumption, and to output the estimated total energy requirement of the work vehicle that needs to be reserved as energy reserve information via a user interface.

12. The system of claim 11, wherein the control unit outputs the energy reserve information via the user interface as remaining work time based on a comparison of the estimated total energy requirement that needs to be reserved and the current energy consumption of the work vehicle as well as the current charge status of the electrical energy store.

13. The system of claim 11, wherein the average energy consumption along the covered route is ascertained by the control unit according to one or more characteristic parameters for the operation of the work vehicle.

14. The system of claim 13, wherein the characteristic parameters relate to one or more of a road surface and a ground type determined by the control unit.

15. The system of claim 13, wherein the characteristic parameters relate to a type of work process.

16. The system of claim 13, wherein the characteristic parameters relate to a detected operation.

17. The system of claim 13, wherein the characteristic parameters relate to a determined surrounding temperature.

18. The system of claim 13, wherein the characteristic parameters relate to one or more of energy which is to be used due to an uphill and energy which can be recovered due to a downhill gradient.

19. The system of claim 13, wherein the estimated total energy requirement is stored by the control unit in a memory unit, along with the covered route and the characteristic parameters.

20. The system of claim 19, wherein any data gaps in terms of the characteristic parameters are inferred by the control unit through approximation, for example using an AI process.
